(19) United States
(12) Patent Application Publication
(10) Pub. No.: US 2005/0231613 A1
(43) Pub. Date: Oct. 20, 2005

(54) Method for providing superimposed video capability on a digital photographic device

(76) Inventors: Vincent Skurdal, Boise, ID (US); Mark Brown, Boise, ID (US); Shane Gehring, Meridan, ID (US)

Correspondence Address: HEWLETT-PACKARD COMPANY;Intellectual Property Administration, P.O. BOX 272400, Fort Collins, CO, 80527-2400, US

(21) Appl. No.: 11/089,563

(22) Filed: Apr. 16, 2004

(51) Int. Cl. H04N 5/262

(52) U.S. Cl. 348/239

(57) ABSTRACT

Primary and secondary digital photographic devices are interconnected using cooperative digital and/or analog input and output ports. Circuitry is used to create a mask region in the image of the primary device into which an image derived from the secondary device is inserted to create time-synchronized superimposed images.

### TECHNICAL FIELD

The present invention relates to digital photographic devices and methods.

### BACKGROUND

Prior solutions that address superimposing video require external mixers or external manipulation hardware or software that is separate from a digital photographic device. Also, because primary and secondary images that are to be superimposed are acquired simultaneously, mixing of the two sources is done in real time. Currently, mixing of video taken from two video sources is difficult because synchronizing the two sources to the actual time is not trivial.

Consider taking video with two video cameras, one imaging a scoreboard and one imaging a sporting event. Mixing these two pieces of video is difficult to synchronize using standard methods. High end systems, such as those used by television stations, for example, utilize complex external mixing hardware to achieve overlays, but their cost is outside the practical limits of weekend videographers.

### SUMMARY OF THE INVENTION

The present invention provides for systems and methods that produce time-synchronized superimposed images taken by low-cost photographic devices. Primary and secondary digital photographic devices are interconnected using cooperative digital and/or analog input and output ports. Firmware (software algorithm) and mixing and masking circuitry are used to create a mask region in the image of the primary device into which an image derived from the secondary device is inserted to create time-synchronized superimposed images.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 is a block diagram of an exemplary embodiment of a system in accordance with the principles of the present invention;

FIG. 2 illustrates exemplary display screens of digital cameras used to implement the exemplary system shown in FIG. 1; and

FIG. 3 illustrates an exemplary method in accordance with the principles of the present invention.

### DETAILED DESCRIPTION

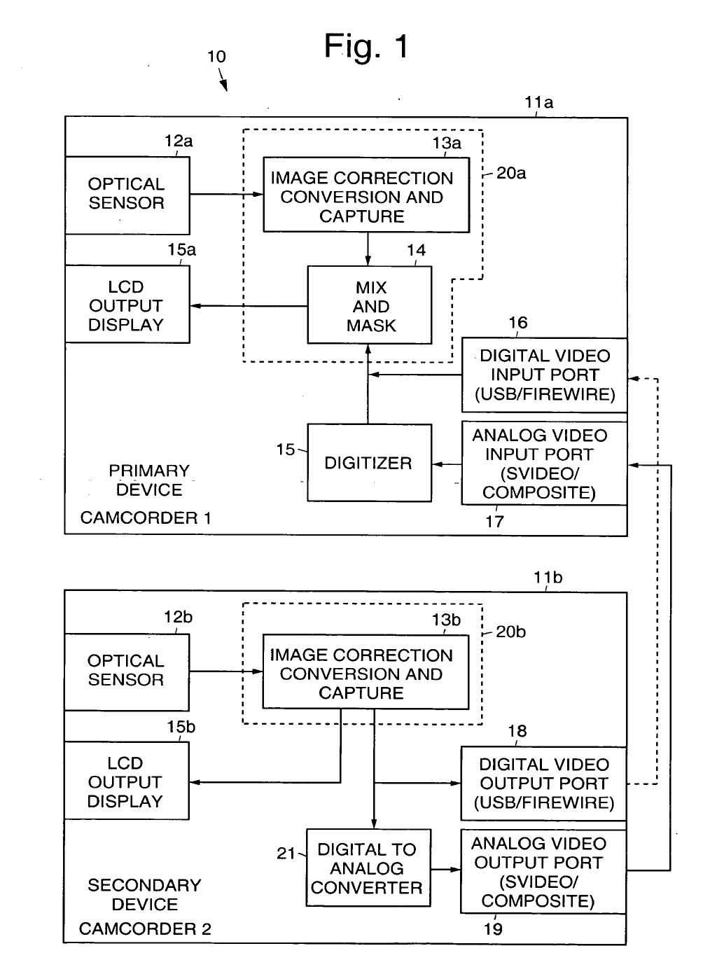

Referring to the drawing figures, FIG. 1 is a block diagram that illustrates an exemplary embodiment of a system 10 in accordance with the principles of the present invention. The exemplary system 10 processes video or photographic images taken by low-cost digital photographic devices to superimpose an image taken by a secondary device 11b onto an image taken by a primary device 11a. More particularly, the system 10 comprises a first or primary digital photographic device 11a, which is also referred to as the primary device 11a, and a second digital photographic device 11b, which is also referred to as the secondary device 11b.

Referring to FIG. 1, the primary digital photographic device 11a is illustrated as a digital camcorder 11a. The primary digital photographic device 11a comprises an optical sensor 12a which is coupled to image correction, conversion and capture circuitry 13a which generates digital images or video. The primary device 11a also comprises a display device 15a, which may be a liquid crystal display (LCD) display device 15a, for example.

The primary digital photographic device 11a comprises a digital video input port 16, which may be a universal serial bus (USB) input port 16 or a Firewire input port 16. The primary digital photographic device 11a also comprises an analog video input port 17, which may be an SVIDEO input port 17 or a composite video port 17. The analog video input port 17 is coupled to a digitizer 15 (or analog-to-digital converter 15).

The image correction, conversion and capture circuitry 13a, along with the digital video input port 16 and the digitizer 15 are coupled to inputs of mix and mask circuitry 14 in accordance with the present invention. An output of the mix and mask circuitry 14 is coupled to the display device 15a.

The image correction, conversion and capture circuitry 13a and mask circuitry 14 may be coupled to or implemented as part of a microprocessor 20a (illustrated using dashed lines). The microprocessor 20a embodies firmware (comprising a software algorithm) that superimposes time-synchronized images in accordance with the present invention, including controlling image masking and mixing (superimposing) operations.

The second digital photographic device 11b comprises an optical sensor 12b that is coupled to image correction, conversion and capture circuitry 13b which generates digital images or video. The secondary device 11b also comprises a display device 15b, which may be a liquid crystal display (LCD) display device 15b, for example.

The second digital photographic device 11b comprises a digital video output port 18, which is coupled to the image correction, conversion and capture circuitry 13b. The image correction, conversion and capture circuitry 13b may be implemented using a microprocessor 20a.

The digital video output port 18 may be a universal serial bus (USB) input port 18 or a Firewire output port 18, for example. The second digital photographic device 11b also comprises a digital-to-analog converter 21 which is coupled between the image correction, conversion and capture circuitry 13b and an analog video output port 19. The analog video output port 19 may be an SVIDEO input port 19 or a composite video port 19, for example. Many currently available cameras and camcorders, for example, have the ability to send composite video, for example, to an output port 19 on the camera or camcorder.

In implementing the present invention, the digital video output port 18 or analog video output port 19 is connected to the corresponding digital video input port 16 or analog video input port 17.

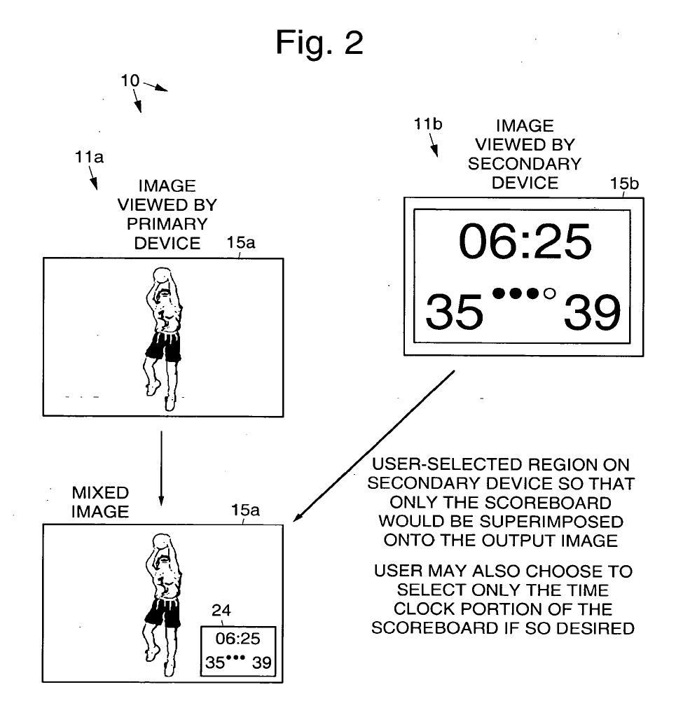

With reference to FIGS. 1 and 2, the digital images or video captured by the image correction, conversion and capture circuitry 13a of the primary device 11a are input to a first input of the mix and mask circuitry 14. Digital images or video output by the secondary device 11b by way of the digital video output port 18 are input to a second input of the mix and mask circuitry 14. Alternatively, analog images or video output by the secondary device 11b by way of the analog video output port 19 are digitized and input to the second input of the mix and mask circuitry 14.

For the purpose of the present invention, the analog images or video output by the secondary device 11b are synchronized to the images or video captured by the primary device 11a within one video frame (about 1/30 second for NTSC video). The primary device 11a digitizes the analog signal input from the secondary device 11b (when the signal from the secondary device 11b is coupled by way of the analog connection 17, 19). The digitized image is stored on a frame by frame basis, and synchronization (sync) signals present in the analog video signal indicate the start of each frame to the digitizer for capturing the analog video. Once the images are stored as individual frames, mixing and/or two frames is a straight forward digital imaging exercise.

Referring to FIG. 2, an exemplary image viewed by the primary device 11a and presented on the display screen 15a of the primary device 11a is shown at the upper left portion of FIG. 2. This image is of a basketball player taking a shot. An exemplary image viewed by the secondary device 11b and presented on the display screen 15b of the secondary device 11b is shown at the upper right portion of FIG. 2. This image is of a scoreboard at the time the basketball player is taking the shot.

The mix and mask circuitry 14 in the primary device 11a is operative to configure the image display space of the display device 15a of the primary device 11a to create a mask region 24 (FIG. 2) within the image displayed on the display device 15a. As is shown in the lower left portion of FIG. 2, a superimposed image is created wherein a rectangular mask region 24 is created into which the image of the scoreboard is inserted, the both the scoreboard and basketball player taking the shot are displayed on the display screen 15a of the primary device 11a.

The mask region 24 is defined by a user using controls on the primary device 11a that implement its user interface, such as the display device 15a with appropriate instructions along with switch or button controls, for example. Common mask regions 24 that may readily be defined include standard geometric shapes (square, rectangle, circle, for example) selected using the user interface of the primary device 11a. However, the user interface of the primary device 11a may also be used to define any desired geometric shape. The user interface is also used to select the location of the desired mask region 24.

Firmware (software algorithm) residing on the microprocessor 20a processes the images or video captured by the primary device 11a to create a mask region 24 (FIG. 2) and mixes images or video derived from the secondary device 11b with the images or video derived from the primary device 11a by inserting an image or video output by the secondary device 11b into the mask region 24. This will be discussed in more detail below.

Thus, in operation, the primary and secondary device 11a, 11b are interconnected using appropriate matching input and output ports 16, 17, 18, 19 to allow the video output of the secondary device 11b to be inserted into a mask region 24 defined by the user on the primary device 11a. The user operates the firmware (software) on primary device 11a using the user interface to create an appropriate superimposed or mask region 24 in the image space of the display device 15a of the primary device 11a. The overlaid or superimposed images are time-synchronized.

The firmware allows a user to select or construct a superimposed region, or mask region 24, based on simple geometric shapes that the user can easily draw on the display 15a of the primary device 11a, onto which the image output of the secondary device 11b is inserted. The firmware (software) then inserts the image viewed by the secondary device 11b into the mask region 24 to superimpose it over the image viewed by the primary device 11a.

Using the firmware on the primary device 11a, additional image features are provided. For example, the overlaid (mask) image can be made “transparent” so that viewers can see through the scoreboard image, for example, so that action behind the mask region 24 is not fully blocked. This can be achieved by using well established image processing techniques that interleave pixels of the master image and secondary image in a checkerboard pattern so as to create an image that appears transparent. Other similar patterns can be used to create more or less transparency appearance. In addition, cropping of the secondary device's image may also be performed by the firmware (software algorithm). This is again achieved by using well established imaging techniques that would utilize arithmetic/logic operations that would include ANDing, ORing, and inversion operations to create a cutout and opaque overlay of the secondary image over the top of the primary image. These well established algorithms are documented in most image processing text books.

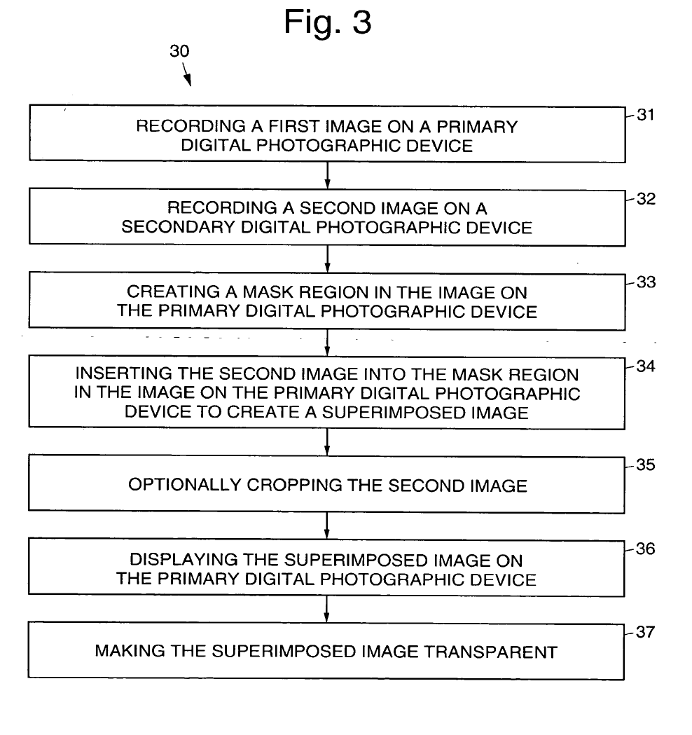

The present invention also provides for a method 30 that superimposes video images derived from a plurality of digital imaging devices 11a, 11b. FIG. 3 illustrates an exemplary method 30 in accordance with the principles of the present invention. The exemplary method 30 comprises the following steps.

A first image is recorded 31 on a primary digital photographic device 11a. A second image is recorded 32 on a secondary digital photographic device 11b. A mask region 24 is created 33 in the image space of the first image on the primary digital photographic device 11a. The second image is inserted 34 into the mask region 24 in the image on the primary digital photographic device 11a to create a superimposed image. The second image is optionally cropped 35. The superimposed image is displayed on the primary digital photographic device 11a. The superimposed image is displayed on the primary digital photographic device 11a is optionally made transparent 37.

A primary advantage of the present invention is that it is cost effective to implement in consumer grade photographic devices. It is becoming increasingly more common for consumers to have both a camcorder and a digital camera with video capture capability and analog/digital video outputs. Also, in the case where the primary device 11a is a digital camcorder, enhanced features, such as cropping, and the like, are easily implemented by way of firmware changes.

The present invention thus provides apparatus and methods that superimpose pictures onto video or images taken by low-cost photographic devices. Uses of the present invention include, for example, (1) superimposing scoreboards into a corner of an action window (i.e., point a primary camera at the action, a secondary at the scoreboard), (2) superimposing crowd reactions to events (great for customer studies), (3) providing virtual rear view mirrors (where two cameras are pointed in opposite directions), (4) the ability to take a picture of a stationary object, map a region as a mask, and superimpose another object into the mask region, (5) provide for kiosk booths that superimpose images, and (6) record coaches on the sidelines while athletes are in action.

Thus, digital photographic systems and methods that provide for superimposed video imagery have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A system comprising:
(1) a secondary digital photographic device comprising:
an optical sensor;
image correction, conversion and capture circuitry coupled to the optical sensor for generating digital images;
a display device for displaying images;
a digital video output port; and
an analog video output port;
(2) a primary digital photographic device comprising:
an optical sensor;
image correction, conversion and capture circuitry coupled to the optical sensor for generating digital images;
a display device for displaying images;
a digital video input port;
an analog video input port;
a digitizer coupled to the analog video input port; and
mix and mask circuitry having an output coupled to the display device and having inputs coupled to the image correction, conversion and capture circuitry, the digital video input port, and the analog video input port; and
(3) firmware operative to create a mask region at a desired location within the image displayed on the display device of the primary device and to insert the images derived from the secondary device into the mask region to display time-synchronized superimposed images derived from the primary and secondary devices.

2. The system recited in claim 1 wherein the primary digital photographic device comprises a digital camcorder.

3. The system recited in claim 1 wherein the secondary digital photographic device comprises a digital camcorder.

4. The system recited in claim 2 wherein the display device comprises a liquid crystal display (LCD) display device.

5. The system recited in claim 2 wherein the digital video input port comprises a universal serial bus (USB) input port.

6. The system recited in claim 2 wherein the digital video input port comprises a Firewire input port.

7. The system recited in claim 1 wherein the analog video input port comprises an SVIDEO input port.

8. The system recited in claim 1 wherein the analog video input port comprises a composite video port.

9. The system recited in claim 1 wherein the image correction, conversion and capture circuitry and mix and mask circuitry comprises a microprocessor.

10. The system recited in claim 1 wherein the mask region has a predefined geometrical shape.

11. The system recited in claim 1 wherein the firmware is operative to crop the image inserted into the mask region.

12. The system recited in claim 1 wherein the firmware is operative to make the image inserted into the mask region transparent.

13. A method that superimposes video images derived from a plurality of digital imaging devices, comprising the steps of:
recording a first image is on a primary digital photographic device;
recording a second image on a secondary digital photographic device;
creating mask region in the image space of the first image on the primary digital photographic device;
inserting the second image into the mask region in the image on the primary digital photographic device to create a superimposed image; and
displaying the superimposed image on the primary digital photographic device.

14. The method recited in claim 13 further comprising the step of cropping the second image.

15. The method recited in claim 13 further comprising the step of making the superimposed image displayed on the primary digital photographic device transparent.
